(19) United States
(12) Patent Application Publication
(10) Pub. No.: US 2019/0162699 A1
(43) Pub. Date: May 30, 2019

(54) Fluid cup and cup holder for use with an electromagnetic detection device

(71) Applicant: Roy L. Rike, Brunswick, ME (US)

(72) Inventor: Roy L. Rike, Brunswick, ME (US)

(21) Appl. No.: 15/732,553

(22) Filed: Nov. 27, 2017

(51) Int. Cl. G01N 27/74

(52) U.S. Cl. CPC G01N 27/74

(57) ABSTRACT

One embodiment of a fluid cup and holder for the fluid cup for use with an electromagnetic detection device, thereby allowing a change to be detected in a fluid placed in the cup.

### CROSS-REFERENCE TO RELATED APPLICATIONS

This application claims the previous benefit of provisional patent application Ser. No. 62/497,687, filed 2016 Nov. 28 by the present inventor. The content of that application is incorporated herein by reference.

### BACKGROUND

### Prior Art

This relates to new matter added to the invention of U.S. Pat. No. 9,046,405 B2, “Liquid Modulated Antenna” (Jun. 2, 2015) issued to the applicant. The new matter consists of: 1) an antenna-containing fluid cup to receive a fluid for analysis by an electromagnetic signal detection device; 2) a holder for the fluid cup allowing the detection device to be positioned on the cup; and 3) an alternative system of operation for the invention in which the antenna is removed from the cup whereby the detection device may detect an electromagnetic field instead of an electromagnetic (radio) signal. Insofar as item 3) removes the antenna from the operating system described in “Liquid Modulated Antenna” (LMA), the current application creates a new system of operation for the invention which, it will be apparent, is logically descended from the invention described in LMA.

LMA describes, “A device for detecting a change in conditions comprising: an RFID [radio frequency identification] circuit, having an antenna, mounted to a substrate; a fluid-filled cell co-located on the substrate and separate from the antenna; and a passage for allowing the fluid inside the cell to flow from the cell onto the antenna to alter the response from the RFID circuit when the fluid flows out of the cell and onto the antenna.” The invention of the current application retains from LMA the RFID circuit in which fluid flows onto an antenna mounted to a substrate. The substrate is here altered into the form of a receptacle, a fluid cup, into which the antenna is placed. The remaining portion of the substrate outside of the cup is formed to act as a support, a holder, for an electromagnetic detection device to be placed on the cup. Fluid here no longer flows from a co-located fluid-filled cell onto the antenna as in LMA, but the fluid is added to the cup from a source external to the substrate. The functions of the cell and passage described in Claim 1 of LMA cited above are therefore to be regarded in the current application as having been moved away from the substrate. Alternative embodiments described in the current application include a fluid cup which is separable from the substrate; a restraint on the holder for the purpose of holding the electromagnetic signal detection device in place on the cup; and the operation of the invention without an antenna being placed in the fluid cup.

The type of electromagnetic detection device being used with the fluid cup and cup holder determines whether the invention can be used without an antenna being placed in the fluid cup. Use of an electromagnetic detection device designed to receive and transmit radio signals (for example, a device measuring Herz units) requires that an antenna be placed in the cup. On the other hand, use of an electromagnetic detection device designed to detect magnetic fields (for example, a device measuring micro-Tesla units), does not require that an antenna be placed in the cup to detect changes in a magnetic field created by the presence of a fluid in the cup. A smartphone, a type of electromagnetic detection device which will be frequently used with the invention, is a device capable of detecting both electromagnetic signals and electromagnetic fields: transmitting and receiving RFID signals, and measuring the strength of magnetic fields through the built-in magnetometer of the smartphone. When a smartphone is the electromagnetic detection device used with the invention, the presence of an antenna in the cup may enhance the strength of the magnetic field strength being detected by the smartphone by reason of the energy of the RFID radio signal which is being simultaneously added to the electromagnetic field as the field is being detected by the magnetometer. The mutual presence of an RFID detecting capability and a magnetic field detecting capability in the same device, the smartphone, supports the assertion of the applicant that the non-antenna system of operation described in paragraph [002] of the current application is logically descended from the system described in LMA.

The most important and immediate scientific and commercial impacts of the invention will result from the novel manner in which the invention converts a smartphone into a device that can be used to identify and characterize a fluid and fluid reactions. When a fluid is added to the cup, the magnetic field being detected from the fluid by the smartphone changes; this change in the magnetic field may then be correlated with a change in the condition of one or more analytical parameters of interest with respect to the fluid such as conductivity, salinity, viscosity, and the presence of metallic particles. The tabulation and study of such deviations in the magnetic field signatures of a fluid produced with the invention will stimulate the development of a smartphone into an accurate analytical instrument useful in many fields.

To the knowledge of the applicant, no prior fluid cup and holder has been so used in combination with an electromagnetic detection device to characterize a fluid and fluid reactions, nor are there known any similar or related techniques of characterizing a fluid and fluid reactions which employ positioning an electromagnetic detection device on a fluid cup.

### SUMMARY

In accordance with one embodiment, an antenna-containing fluid cup and holder to be used with an electromagnetic detection device.

### ADVANTAGES

The invention will stimulate the novel use of a smartphone as a device for analyzing fluids, thereby providing scientists, engineers, and the general public with an inexpensive device for generating and disseminating health, safety, environmental, and other types of commercially valuable information.

### DRAWINGS—FIGURES

In the drawings, a non-antenna embodiment is to be understood as being paired with each antenna-containing embodiment, requiring the subtraction only of antenna 13 from fluid cup 12 to create the required non-antenna cup.

FIG. 1A to 1C show an antenna-containing fluid cup and cup holder, then an electromagnetic detection device (here, a smartphone) placed upon the fluid cup and holder.

FIG. 2A to 2D show an antenna-containing fluid cup and holder having a cup which is separable from the holder, the holder having locating tabs attached as a restraint for the purpose of holding an electromagnetic device in place over the cup, then such a device (here, a smartphone) placed upon the fluid cup and holder.

Drawings-Reference Numerals

| | | | |
|---|---|---|---|
| 11 | cup holder | 12 | fluid cup |
| 13 | antenna | 14 | electromagnetic detection device |
| 15 | restraint (locating tab, x 4) | 16 | separable cup |

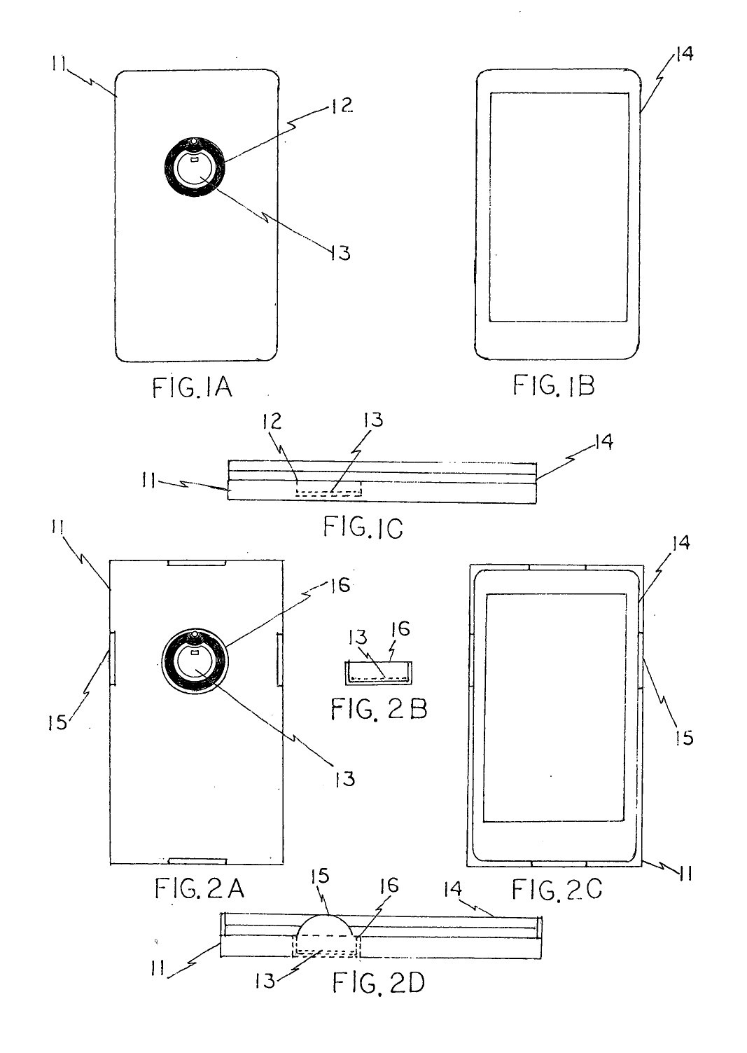

### DETAILED DESCRIPTION—FIG. 1A-1C—FIRST EMBODIMENT

An overhead view of a cup holder 11 and fluid cup 12 is shown in FIG. 1A with an antenna 13 (here, a circular RFID tag antenna) placed in the fluid cup. When an electromagnetic detection device (here, a smartphone) 14 is placed on a holder 11 constructed with the same length and width as the device, an overhead view of the combination of holder 11 and device 14 appears as shown in FIG. 1B. The cross-sectional view of FIG. 1C shows that the fluid cup 12 has been positioned in the holder 11 so that the fluid cup 12 lies opposite the location of the electromagnetic sensors mounted inside the detection device 14.

### OPERATION—FIG. 1

The fluid cup and cup holder is operated by placing fluid in the cup and positioning the electromagnetic detection device over the cup so that the electromagnetic sensors of the device lie opposite the cup. A reading is then taken from the electromagnetic detection device.

### ADDITIONAL EMBODIMENTS—FIGS. 1, 2

Three additional embodiments of the invention are created by: 1) removing the antenna 13 from the first embodiment (see paragraphs [004] and [009]); 2) adding a separable cup 16 and restraint 15 for positioning the electromechanical detection device on the cup holder 11 as shown in FIGS. 2; and 3) removing the antenna 13 from the second embodiment (see paragraphs [004] and [009]). Note that FIG. 2 shows a cup holder 11 having a length and width greater than those of the electromagnetic detection device 14 to allow for the attachment of the restraint 15 (here, tabs) to the cup holder 11.

### CONCLUSION, RAMIFICATIONS, AND SCOPE

Accordingly, the reader will see that the liquid cup and cup holder when used with an electromagnetic detection device creates a novel method of characterizing a fluid and fluid reactions. The invention will be of use to scientists, engineers, and the general public in discovering and disseminating new types of commercially valuable information.

I claim:

1. A device for detecting a change in a fluid with an electromagnetic detection device comprising:
a cup to hold the fluid; and a holder for the cup.

2. The device in claim 1, wherein an antenna is placed in the cup.

3. The device in claim 1, wherein the cup is separable from the holder.

4. The device in claim 1, wherein the holder contains a means of holding the electromagnetic detection device in place on the cup.

5. A method of forming a device for detecting a change in a fluid, comprising:
forming a fluid cup and cup holder for use with an electromagnetic detection device.

7. The method of claim 5, wherein the cup is separable from the holder.

8. The method of claim 5, wherein the holder contains a means of holding the electromagnetic detection device in place on the cup.

9. A system for detecting a change in a fluid, comprising:
a fluid cup; a holder for the fluid cup; and an electromagnetic detection device for use with the cup and holder to determine a change in the condition of a fluid placed in the cup.

10. The system of claim 9, wherein an antenna is placed in the cup.

11. The system of claim 9, wherein the cup is separable from the holder.

12. The system of claim 9, wherein the cup holder contains a means of holding the electromagnetic detection device in place on the cup.
